(19) United States
(12) Patent Application Publication
(10) Pub. No.: US 2009/0000121 A1
(43) Pub. Date: Jan. 1, 2009

(54) Bending tool and method of manufacture

(76) Inventor: Stuart Julian Filhol, Castlefreke (IE)

Correspondence Address: WALTER A. RODGERS;RODGERS & RODGERS, 6100 LAKE FORREST DRIVE, SUITE 340, ATLANTA, GA, 30328, US

(21) Appl. No.: 12/215,141

(22) Filed: Jun. 25, 2008

(30) Foreign Application Priority Data
Jun. 26, 2007 (GB) 0712361.5

(51) Int. Cl. A61C 3/00; A61C 5/02

(52) U.S. Cl. 29/896.1; 433/3

(57) ABSTRACT

This invention relates to bending tool and to a method of manufacturing a bending tool, in particular to a bending tool for bending a dental pin. The bending tool comprises a shaft with two elements projecting from the shaft, the elements having facing surfaces, the facing surfaces being curved, the facing surfaces being separated by a distance at least as great as the diameter of the dental pin. The method comprises the steps of providing a shaft, drilling two holes into the end of the shaft, the holes being separated by a distance slightly greater than the diameter of the dental pin, and securing an element in each of the drilled holes.

### FIELD OF THE INVENTION

This invention relates to bending tool and to a method of manufacturing a bending tool, and in particular to a bending tool for bending a dental pin.

### BACKGROUND OF THE INVENTION

Dental pins are in widespread use by dental practitioners for the repair of a damaged or diseased tooth. Typically, parts of the damaged or diseased tooth will be removed until only undamaged and disease-free tooth remains, a hole will be drilled into the tooth, and a dental pin will be inserted into the hole and secured there by a screw thread or cement. When the dental pin has been secured in position a crown or replacement part of the tooth can be secured to the dental pin, so that the dental pin acts to secure the replacement part of the tooth to the remaining part of the original tooth.

Dental pins are distinguished by the different parts of the tooth they are intended to be secured to. Certain dental pins are designed to be fitted into the root canal of the tooth. Another type of dental pin is designed to be fitted into the dentine of the tooth, and it is this type of dental pin to which the present invention is primarily directed.

Dental pins which are designed to be fitted into the dentine of the tooth are most often used when only a small part of the original tooth has been lost, as in the case of a tooth which has become chipped for example, but for which the chip is either too large, or is located in a position, which will not allow a standard filling to be applied. Such dental pins are also sometimes used when large parts of the tooth have been lost.

It will be understood that the present invention also has utility with other types of dental pins, but it is with dental pins designed for be fitted into the dentine of a tooth for which the invention is expected to have its greatest utility. For brevity therefore, the term “dental pin” will hereinafter be used to refer to a dental pin designed to be fitted into the dentine.

Dental pins have been available for many decades. Dental pins have been made of solid gold, stainless steel or titanium. Titanium has considerable benefits in that it is biologically inert, medically safe, and is compatible with all known dental materials.

The grade of titanium used for dental pins has an advantage in that the dental pins can be bent to suit the particular patient's tooth. Thus, when the dental pin is to be fitted to the tooth the dental practitioner will have to choose the location and orientation of the drilled hole so that the pulp, root canal and enamel are avoided, and so that the dental pin can be made secure. The location and orientation of the drilled hole will not always match the requirements of the dental pin to best secure the new tooth material, and so to accommodate the new tooth material it is necessary for the practitioner to bend the originally straight dental pin after insertion.

### DESCRIPTION OF THE PRIOR ART

A bending tool for dental pins has been known since around the 1940's, which in essence comprises a flat blade (similar to the blade of a small screwdriver), with a saw cut through the blade to provide a bifurcated blade. The saw cut was sized to exceed slightly the diameter of the dental pin, and in use the bifurcated parts of the blade would be passed around the pin and the blade twisted so as to bend the pin.

There are a number of disadvantages with this known bending tool. The first disadvantage is that the saw cut produces a right-angled corner around which the dental pin is bent, and this is not ideal for the bending action required. The second disadvantage is that the blade is relatively wide in comparison to the width of the saw cut, and when the blade is twisted its end will often engage the original tooth and act as a lever causing the saw cut to move away from the tooth during the twisting/bending movement. This latter problem is exacerbated by the usual desire of the practitioner to bend the dental pin as close to the original tooth as possible. The third disadvantage is the difficulty in providing a hard surface finish on the saw cut which could be polished or otherwise made smooth so as not to damage the dental pin during the bending operation.

Largely because of these disadvantages, it is understood that the known bending tool has not been in widespread use for many years, and is believed to be no longer commercially available. It is also understood that whilst practitioners would prefer to use a bending tool if a suitable tool was available, the lack of availability of a suitable tool results in practitioners having to seek other means of bending dental pins. Accordingly, practitioners typically bend a dental pin by pressing the proximal end in the desired direction once the distal end is held in the patient's original tooth. However, this method is potentially damaging to the original tooth, in particular at the point at which the dental pin exits the original tooth, the edge of the drilled hole at the exit bearing most of the bending load exerted by the practitioner, and perhaps breaking or otherwise becoming damaged under that load. Also, the practitioner must take great care during the bending operation, because if a titanium dental pin is bent too far it is liable to fracture if it is subsequently attempted to (un)bend the pin back to the desired position.

There is therefore required a bending tool for a dental pin which will be useful to practitioners without the disadvantages of the prior art bending tool.

### SUMMARY OF THE INVENTION

According to the invention therefore, there is provided a bending tool for bending a dental pin, the tool comprising a shaft with two elements projecting from the shaft, the elements having facing surfaces, the facing surfaces being curved, the facing surfaces being separated by a distance at least as great as the diameter of the dental pin.

Because the facing surfaces of the elements are curved the dental pin can be bent around a curved surface, which is ideally suited to the bending action.

Desirably, the elements are substantially circular. The use of substantially circular elements reduces the overall width of the bending tool and therefore reduces the lever action of the tool upon the patient's tooth. Alternatively, the overall width of the tool can be reduced further by flattening or tapering the outside edges of the elements, or otherwise reducing the width of the elements.

A known dental pin is 0.76 mm in diameter, and so the separation of the facing surfaces of the elements is at least 0.76 mm, and ideally very slightly greater than that so as to provide a clearance fit around the dental pin. The force required to bend a titanium dental pin of 0.76 mm diameter is not great, and elements of stainless steel or the like having a cross-sectional diameter of 0.60 mm will typically be rigid enough to permit bending of the dental pin without themselves becoming bent or breaking. With such dimensions, it will be understood that the shaft needs to be slightly more than 1.96 mm wide.

Ideally, the shaft is not much wider (if at all) than the overall width of the two elements plus their separation, so that the bending tool may be more easily inserted into the correct location in the patient's mouth, and may more easily be manipulated in the patient's mouth without obscuring the practitioner's view. Similarly, the shaft is preferably at least around 20 mm long, and ideally more than 40 mm long, again so that the bending tool may be more easily inserted and manipulated in the patient's mount.

It will also be understood that the elements need only to be around 1 mm in length in order to span the full diameter of the dental pin. Since the practitioner will ordinarily seek to place the bending tool around the dental pin until the dental pin engages the end of the shaft, making the elements longer than substantially the diameter of the dental pin will be unnecessary and will increase the likelihood that the elements will foul one or other of the patient's teeth during the bending movement.

There is also provided a method of making a bending tool for a dental pin comprising the steps of:

{i} providing a shaft

{ii} drilling two holes into the end of the shaft, the holes being separated by a distance slightly greater than the diameter of the dental pin

{iii} inserting an element into each of the drilled holes, and securing the elements therein.

In alternative methods the shaft and elements are integral, perhaps being moulded from ceramic material for example, or else made by a sintering process. Such a method allows the elements to be of a different material to the shaft, and in particular a harder material which is less likely to bend under the loads applied. Also, the material of the elements can be susceptible to polishing or other surface finishing intended to reduce the likelihood of damage to the dental pin.

Ideally, the shaft is made of stainless steel and the elements are made from hardened stainless steel or hardened high speed steel. Elements of these materials are readily available at the dimensions of interest, and are produced for example as blanks for drill bits.

In this method, because the elements are fitted into preformed holes in the shaft, they can be polished or otherwise have the required surface finish applied thereto, before they are fitted to the shaft, so that access between the elements is not required during the surface finishing operation.

### BRIEF DESCRIPTION OF THE PREFERRED EMBODIMENTS

The invention will now be described in more detail, by way of example, with reference to the accompanying drawings, in which:

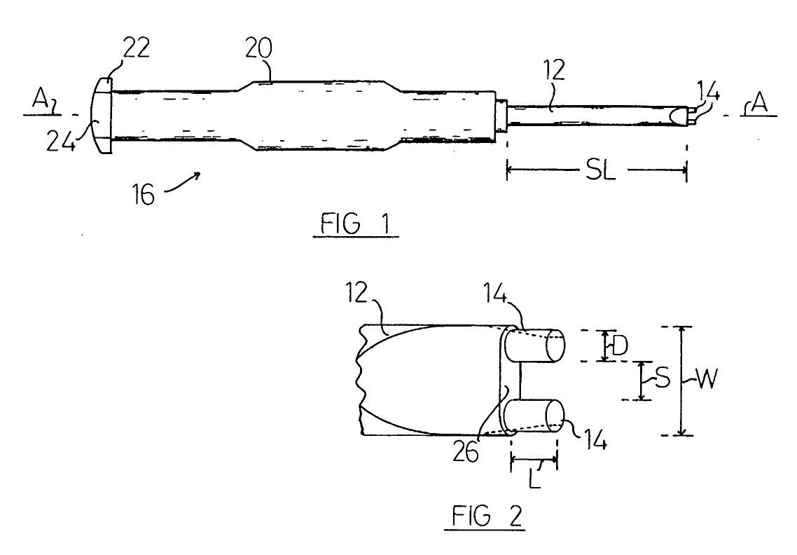

FIG. 1 shows a side view of a bending tool according to the present invention; and

FIG. 2 shows an enlarged view of the end of the shaft of the bending tool of FIG. 1.

### DETAILED DESCRIPTION

The bending tool 10 comprises a substantially linear shaft 12 having two bending elements 14 secured to its free end. The other end of the shaft is connected to a handle 16, which handle is sized and shaped to be easily manipulated by a dental practitioner. In this embodiment the shaft 12 and the handle 16 are generally circular in cross-section.

In this embodiment the handle 16 comprises an elongated rod with an enlarged central section 20 (which can be knurled to provide a good grip), and a cap 22. The cap 22 is generally circular in end view, but has two parallel flats 24 (only one of which can be seen in FIG. 1) which can accept a spanner or wrench whereby to apply additional torque to the bending tool if required, or to accept a tool to measure the angle of bending.

The shaft 12 is of circular cross-section for most of its length, but as better seen in FIG. 2 its free end is machined or otherwise formed into a tapering “blade” 26. The distal end of the shaft 12 therefore has a generally rectangular form, but with curved edges matching the (unmachined) curvature of the shaft 12.

The bending elements 14 comprise pins of substantially circular cross-section, which elements are fixed into suitably-sized holes which have been drilled into the blade 26 of the shaft 12. The use of substantially circular bending elements allows the drilling of holes into the shaft 12. Accordingly, only the distal ends of the pins forming the bending elements 14 are visible in FIG. 2, the proximal ends being embedded and secured within drilled holes in the blade 26. The pins are suitably secured into the drilled holes in the blade 26 by adhesive, but alternative (or additional) methods of securing the pins can be used.

The facing surfaces of the bending elements 14 are separated by a distance S, which is slightly greater than the diameter of the dental pin with which the bending tool is designed to be used. Ideally, the bending elements are a sliding fit around the dental pin.

Dental pins are known to have diameters of 0.6 mm and 0.76 mm, and a bending tool can be produced for each diameter of dental pin (although a bending tool which is suitable for use with a 0.76 mm dental pin could also be used to bend a 0.60 mm dental pin).

The bending elements 14 have a length L, which dimension is similar to the separation S. Thus, it will be understood that dental pins have a substantially circular cross-section, and when it is desired to bend a dental pin the bending tool will be placed with the bending elements 14 to either side of the dental pin, and with the dental pin ideally engaging the blade 26. In order to engage the dental pin the bending elements 14 therefore need to project from the blade by a distance greater than half the diameter of the dental pin, but making the bending elements longer than this, and suitably slightly longer than the diameter of the dental pin, makes it easier for the dental practitioner to apply the tool to the dental pin without a significant increase in the likelihood that the bending elements will foul the patient's tooth during the bending operation. Also, longer elements reduce the likelihood that the bending tool will slip off the dental pin during the bending operation, particularly if the longitudinal axis of the bending tool cannot be aligned perpendicular to the dental pin.

The bending elements 14 in this embodiment are substantially circular, with a cross-sectional diameter D of 0.58 mm. The bending elements are ideally made of a hard material such as hardened stainless steel or hardened high speed steel, and since such materials are harder than titanium the diameter D of the pins can be less than the diameter of the dental pin (i.e. the dimension D can be smaller than the dimension S).

The overall width W of the blade 26 is only slightly greater than the combined dimension D+S+D, specifically because the blade 26 extends slightly beyond the bending elements 14 as shown.

When it is desired to bend a dental pin which has been inserted into a patient's tooth, the practitioner inserts the bending tool into the patient's mouth, and manipulates the tool until the bending elements 14 are located to either side of the dental pin, and the dental pin ideally engages the blade 26. The bending tool is oriented with its longitudinal axis A-A aligned with the desired bending axis, i.e. aligned perpendicular to the plane in which the dental pin is to be bent. The practitioner then twists the bending tool around its longitudinal axis A-A to impart the required bend into the dental pin.

It will be understood that during the bending movement, the facing surface of one of the bending elements 14 acts as the former around which the dental pin is bent, whilst the facing surface of the other of the bending pins 14 acts as the driver forcing the dental pin around the former. Because the facing surfaces of the bending elements 14 are curved, and in this embodiment substantially circular, the former is curved which facilitates a smooth bend, and the driver is curved which allows it to ride smoothly over the dental pin as the dental pin is being bent. The bending elements are preferably polished or otherwise made smooth before insertion into the blade 26, so as to facilitate the bending operation and avoid damage to the dental pin.

It will be understood that the dimension W should be minimised, so as to reduce the likelihood that the blade 26 will foul the patient's tooth during the bending action; should the blade 26 foul the patient's tooth then the bending elements 14 would both be forced away from the patient's tooth as the dental pin is bent, so increasing the radius of curvature of the bend in the dental pin.

In FIG. 2, an alternative tapered construction of the shaft and pins is shown in dotted lines, i.e. the outer edges of the shaft and pins are removed up to the dotted lines. In that embodiment, the width of the blade is reduced (and also the width of the bending elements are reduced), so as to further reduce any tendency of the bending tool to foul the patients tooth, and to minimise the lever action if the bending tool does foul the patient's tooth, during the bending movement.

It will be understood that any tapering of the bending elements should be restricted to the outside surfaces of the bending elements, which surfaces play no part in the bending action. In particular, the facing surfaces of the bending elements 14 in the longitudinal direction A-A should be maintained substantially parallel so that there is no tendency for the bending tool to slide off the dental pin during the bending action, the curvature of the facing surfaces being restricted to the cross-sectional plane.

Even if the end of the shaft and bending elements are tapered as shown in dotted lines, it is desired that any corners or sharp edges be rounded off.

The shaft 12 and handle 16 are preferably made of stainless steel. Such material is ideally suited to dental applications, and can be cleaned thoroughly after use.

The shaft has a length SL, which is desirably at least 20 mm, and preferably around 40 mm. It will be understood that the shaft 12 is relatively thin and therefore hardly obscures the practitioner's view of the bending elements. Also, a thin shaft reduces the likelihood of the shaft fouling a part of the patient's mouth during insertion (and twisting) of the bending tool.

1. A bending tool for bending a dental pin, the tool comprising a shaft with two elements projecting from the shaft, the elements having facing surfaces, the facing surfaces being curved, the facing surfaces being separated by a distance at least as great as the diameter of the dental pin.

2. The bending tool according to claim 1 in which the elements are substantially circular in cross-section.

3. The bending tool according to claim 2 in which the elements have a cross-sectional diameter of approximately 0.60 mm.

4. The bending tool according to claim 1 in which the elements have outer surfaces opposed to their facing surfaces, and in which the outer surfaces are tapered.

5. The bending tool according to claim 1 in which the elements are made of stainless steel.

6. The bending tool according to claim 1 in which the shaft is more than 20 mm long.

7. The bending tool according to claim 1 in which the elements are approximately 1 mm in length.

8. The bending tool according to claim 1 in which the elements are of a different material to the shaft.

9. A method of manufacturing a bending tool for a dental pin comprising the steps of:
{i} providing a shaft
{ii} drilling two holes into the end of the shaft, the holes being separated by a distance slightly greater than the diameter of the dental pin
{iii} inserting an element into each of the drilled holes, and securing the elements therein.

10. The method according to claim 10 in which at least part of each of the elements is polished prior to step {iii.}
